(19) United States
(12) Patent Application Publication
(10) Pub. No.: US 2025/0178673 A1
(43) Pub. Date: Jun. 5, 2025

(54) VEHICLE FRAME STRUCTURE

(71) Applicant: HONDA MOTOR CO., LTD., Tokyo (JP)

(72) Inventors: Tomohide SEKIGUCHI, Tokyo (JP); Tadashi NAITO, Tokyo (JP); Kenichiro FUKAGAWA, Tokyo (JP); Kanji FUJII, Tokyo (JP)

(21) Appl. No.: 18/960,727

(22) Filed: Nov. 26, 2024

(30) Foreign Application Priority Data
Nov. 30, 2023 (JP) 2023-203446

(51) Int. Cl. B62D 25/08; B62D 21/15

(52) U.S. Cl. CPC B62D 25/085; B62D 21/152

(57) ABSTRACT

A first part of a side frame as a vehicle frame structure includes: a pair of opposed wall portions extending in a front-rear direction of a vehicle body; a coupling wall portion extending in the front-rear direction of the vehicle body and coupling the pair of opposed wall portions to each other; a straight rib and a V-shaped rib as a plurality of bridging ribs formed so as to couple the pair of opposed wall portions to the coupling wall portion; and a fragile portion formed on the opposed wall portions and/or the coupling wall portion. The fragile portion is formed to be located between two adjacent ones of the bridging ribs in the front-rear direction of the vehicle body.

### BACKGROUND OF THE INVENTION

### 1. Field of the Invention

The present invention relates to a frame structure of a vehicle.

### 2. Description of the Related Art

In recent years, from the viewpoint of improving the global environment to mitigate natural disasters, there has been a demand for improving automobiles' fuel efficiency. On the other hand, there has been a demand for maintaining or improving vehicles' collision safety. TO fulfill these demands, development of vehicle frame structures that absorb collision energy have been in underway. As such a vehicle frame structure, Patent Literature 1 discloses a front body (engine compartment) formed of a single cast component with a plurality of ribs.

### PRIOR ART DOCUMENT(S)

### Patent Literature(s)

Patent Literature 1: CN115158479A

While the rigidity of such a structure can be set to high, the high rigidity makes it difficult for the structure to be deformed and crushed, leaving room for improvement in terms of collision energy absorption. Also, even if such a structure is deformed, there is a risk that there may be a portion left uncrushed, preventing sufficient absorption of the collision energy.

### SUMMARY OF THE INVENTION

The present invention has been made in view of the above circumstances, and an object thereof is to provide to a vehicle frame structure capable of efficiently absorbing collision energy and consequently contributing to development of sustainable transport systems.

To achieve the above-described object, a vehicle frame structure of the present invention includes: a pair of opposed wall portions extending in a front-rear direction of a vehicle body; a coupling wall portion extending in the front-rear direction of the vehicle body and coupling the pair of opposed wall portions to each other; a plurality of bridging ribs formed so as to couple the pair of opposed wall portions to the coupling wall portion; and a fragile portion formed on the opposed wall portions and/or the coupling wall portion, and the fragile portion is formed to be located between two adjacent ones of the bridging ribs in the front-rear direction of the vehicle body.

According to the present invention, it is possible to efficiently absorb collision energy and consequently contribute to development of sustainable transport systems.

### BRIEF DESCRIPTION OF THE DRAWINGS

FIG. 1 is a side view schematically showing a vehicle body structure to which a vehicle frame structure according to an embodiment of the present invention is applied.

FIG. 2 is a bottom view schematically showing the vehicle frame structure according to the embodiment of the present invention.

FIG. 3 is a side view schematically showing the vehicle frame structure according to the embodiment of the present invention.

FIG. 4 is a bottom view schematically showing a first part and a second part of the vehicle frame structure according to the embodiment of the present invention.

FIG. 5 is a cross-sectional view along the V-V line in FIG. 4.

### DETAILED DESCRIPTION OF THE EMBODIMENTS

Next, an embodiment of the present invention will be described in detail with reference to the drawings as appropriate by taking a case where a vehicle frame structure of the present invention is applied to a front side frame as an example. In the drawings to be referred to, “FRONT” and “REAR” indicate the front-rear direction in the direction of travel of a vehicle, and “LEFT” and “RIGHT” indicate the left-right direction (vehicle width direction) as viewed from the driver's seat. Also, since the vehicle frame structure is applied to a front section of the vehicle body, the outward direction (outer side) in the front-rear direction of the vehicle body is the forward direction (front side), and the inward direction (inner side) in the front-rear direction of the vehicle body is the rearward direction (rear side) (the directions and sides are reversed when the vehicle frame structure is applied to a rear section of the vehicle body).

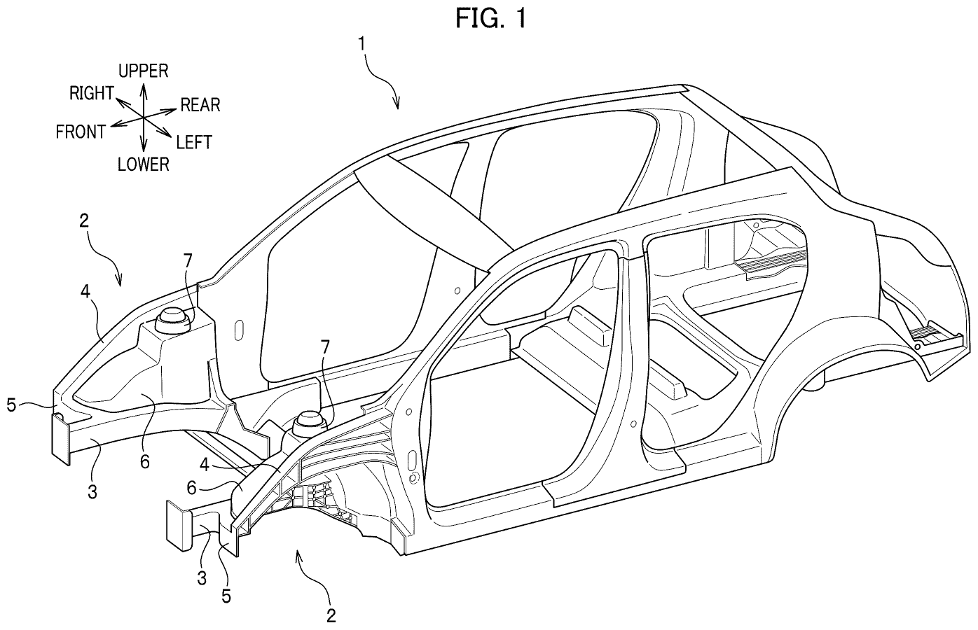

As shown in FIG. 1, a vehicle body structure 1 according to the embodiment of the present invention is formed of die-cast objects formed by a die casting method with a material containing aluminum at least partly (aluminum die casting method). The vehicle body structure 1 includes front members 2 and 2 as a pair in the vehicle width direction at a front section of the vehicle body.

### Front Members

Each front member 2 represents an example of a vehicle body structure member to which the vehicle frame structure of the present invention is applied, and is a member forming a front section of the vehicle body structure 1. The front member 2 is a die-cast object formed by the aluminum die casting method (integrally molded), and includes a side frame 3, an upper member 4, a coupling part 5, a wheel house 6, and a damper housing 7 integrally with one another.

### Side Frames (Front Side Frames)

Each side frame 3 represents an example of the vehicle frame structure of the present invention, and is a frame with an open cross-sectional shape extending in the front-rear direction around the end of a lower section of the vehicle body in the vehicle width direction. The side frame 3 will be described later in detail.

### Upper Members

Each upper member 4 is a frame with an open cross-sectional shape extending in the front-rear direction at a position outward of the side frame 3 in the vehicle width direction. The upper member 4 assumes a shape complying with upper end portions of the wheel house 6 and the damper housing 7, and is formed so as to extend farther upward toward the rear side.

### Coupling Parts

Each coupling part 5 is a frame with an open cross-sectional shape extending in the vehicle width direction, and is a part coupling a portion of the side frame 3 located slightly rearward of its front end portion and a front end portion of the upper member 4. An inner end portion of the coupling part 5 in the vehicle width direction is joined to an outer end portion of the side frame 3 in the vehicle width direction located slightly rearward of its front end portion. An outer end portion of the coupling part 5 in the vehicle width direction and its rear end portion are joined to the front end portion of the upper member 4. The rear end portion of the coupling part 5 is joined to a front end portion of the wheel house 6.

### Wheel Houses

Each wheel house 6 is a part for housing a wheel (a front wheel in the present embodiment) in a space formed on the outer side of the wheel house 6 in the vehicle width direction. The front end portion of the wheel house 6 is joined to the rear end portion of the coupling part 5. An inner end portion of the wheel house 6 in the vehicle width direction and its lower end portion are joined to an outer end portion of the side frame 3 in the vehicle width direction and its upper end portion. An outer end portion of the wheel house 6 in the vehicle width direction and its upper end portion are joined to an inner end portion of the upper member 4 in the vehicle width direction and its lower end portion.

### Damper Housings

Each damper housing 7 is a part provided on top of the wheel house 6 to house a damper on which a wheel (front wheel) is to be suspended.

### Side Frames (Front Side Frames)

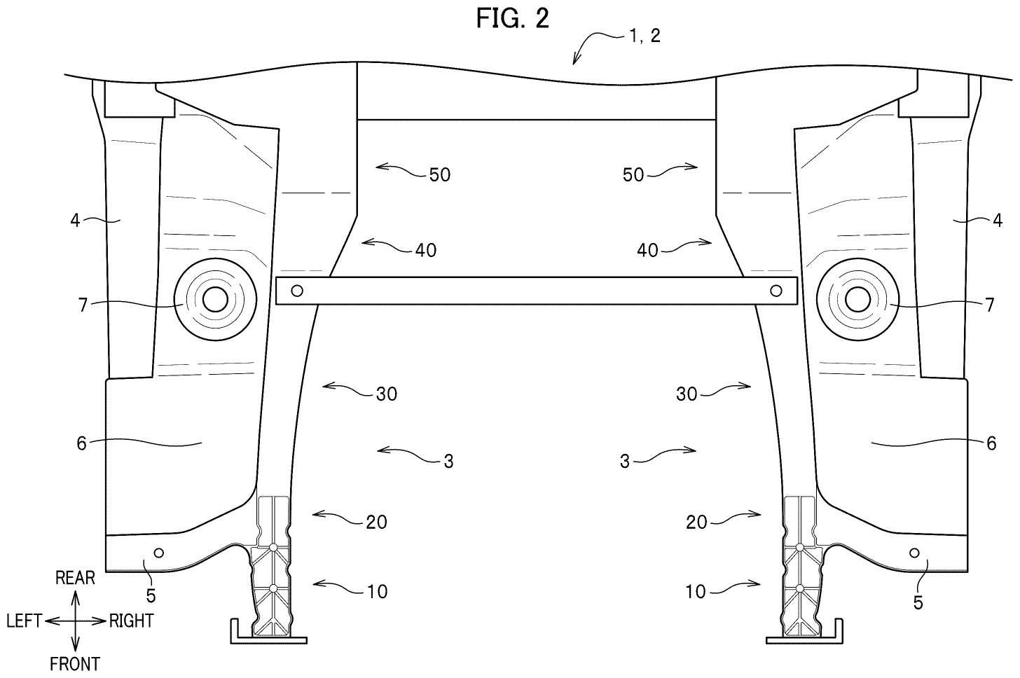

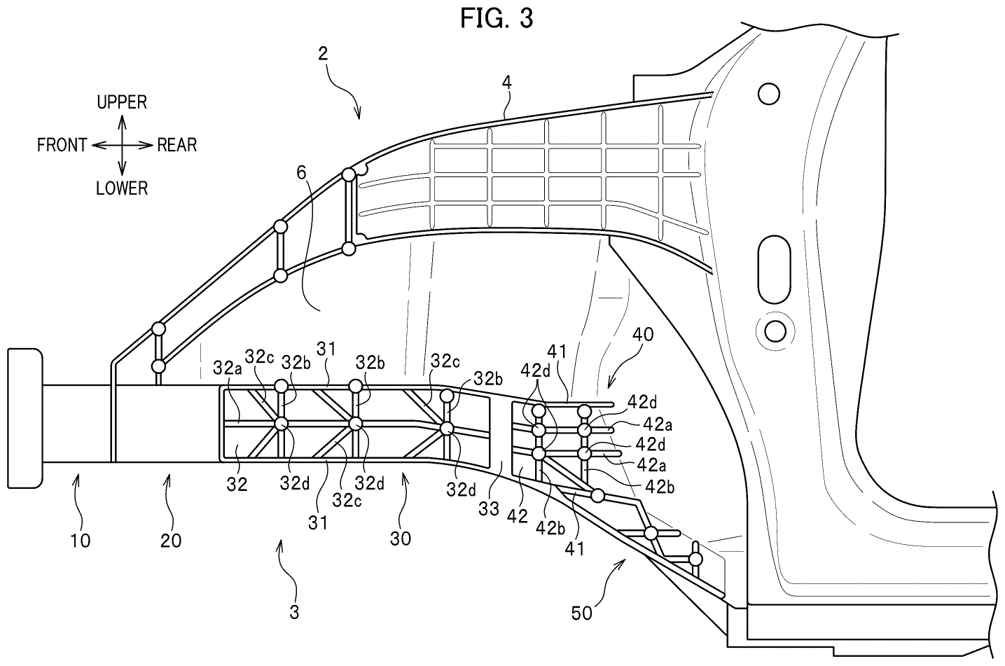

As shown in FIGS. 2 and 3, each side frame 3 integrally includes a first part 10, a second part 20, a third part 30, a fourth part 40, and a fifth part 50 in this order from the front side toward the rear side.

### Side Frame: First Part

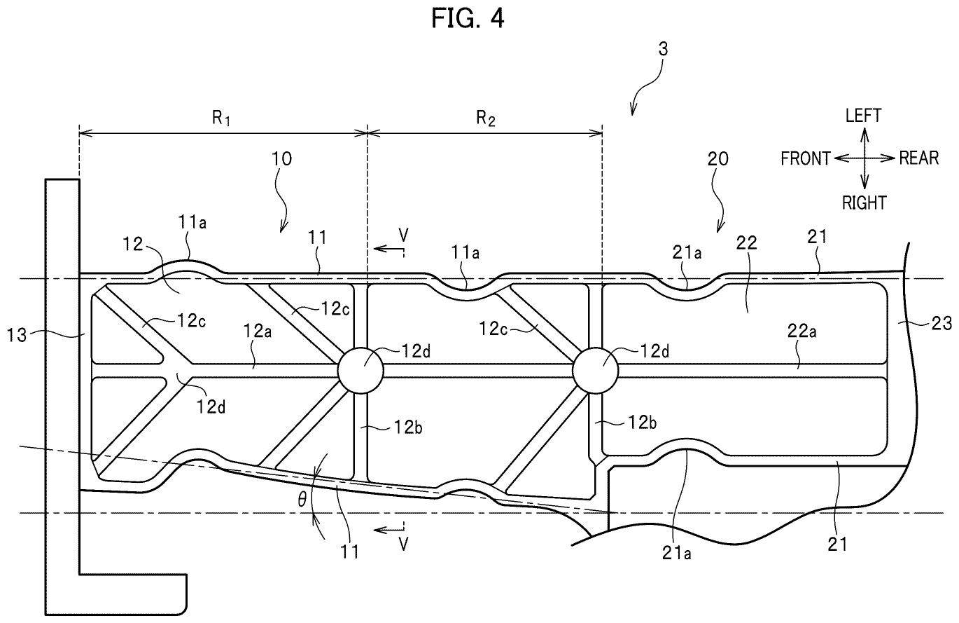

The first part 10 forms a front portion of the side frame 3, and is a part that protrudes forward (outward in the front-rear direction of the vehicle body, and rearward when the side frame is employed at a rear section of the vehicle body) beyond the coupling part 5. As shown in FIG. 4, the first part 10 integrally includes a pair of opposed wall portions 11 and 11, a coupling wall portion 12 coupling the opposed wall portions 11 and 11, and a flat plate portion 13. Note that the first part 10 and the second part 20 of the side frame 3 employed for the right side of the vehicle are depicted in FIG. 4.

### Opposed Wall Portions

The opposed wall portions 11 and 11 are long plate-shaped portions extending in the front-rear direction, and are separated from and opposed to each other. In the present embodiment, the opposed wall portions 11 and 11 extend in the front-rear direction and in the upper-lower direction, and are separated from and opposed to each other in the vehicle width direction. Specifically, one of the opposed wall portions 11 and 11 is an inner wall portion disposed on the inner side in the vehicle width direction while the other of the opposed wall portions 11 and 11 is an outer wall portion disposed on the outer side in the vehicle width direction.

The gap between the pair of opposed wall portions 11 and 11 becomes wider toward the rear side. In the present embodiment, the opposed wall portion 11 which is the inner wall portion is parallel to the front-rear direction of the vehicle body. The opposed wall portion 11 which is the outer wall portion is inclined so as to extend farther outward in the vehicle width direction toward the rear side, and is inclined with respect to the front-rear direction of the vehicle body at an inclination angle θ within a range between 0° and 5°, exclusive of 0° and inclusive of 5°.

### Fragile Portions

A plurality of fragile portions 11a are formed on each of the opposed wall portions 11 and 11. The fragile portions 11a are formed to be more fragile than other portions of the opposed wall portions 11, more specifically, formed to be deformed in a collapsing manner (crushed) by a load in the front-rear direction. In the present embodiment, each fragile portion 11a is a bead (recess) recessed toward the inner side or outer side of the opposed wall portion 11. The plurality of fragile portions 11a are arrayed in the front-rear direction (the longitudinal direction of the opposed wall portion 11). In the present embodiment, the fragile portions 11a formed on the opposed wall portion 11 which is the inner wall portion are recessed outward in vehicle width direction, while the fragile portions 11a formed on the opposed wall portion 11 which is the outer wall portion are recessed inward in the vehicle width direction. The fragile portions 11a of the inner wall portion and the fragile portions 11a of the outer wall portion are provided at the same positions in the front-rear direction, in other words, aligned in the vehicle width direction.

Note that the directions in which the beads (recesses) as the fragile portions 11a are recessed can be set as appropriate. In the present embodiment, of the fragile portions 11a formed on the opposed wall portion 11 which is the inner wall portion, the fragile frontmost fragile portion 11a is recessed inward in the vehicle width direction. With this configuration, the bending direction of a front end portion of the first part 10 will be controlled to be inward in the vehicle width direction, which will enable the first part 10 to be crushed and bent in a preferable manner.

### Coupling Wall Portion

The coupling wall portion 12 is formed so as to couple the pair of opposed wall portions 11 and 11. In the present embodiment, the coupling wall portion 12 is an upper wall portion extending in the front-rear direction and in the vehicle width direction and coupling upper end portions of the pair of opposed wall portions 11 and 11 to each other.

On the coupling wall portion 12, there are formed a parallel rib 12a being parallel to the opposed wall portions 11 and 11, a plurality of straight ribs 12b and V-shaped ribs 12c as bridging ribs laid between the opposed wall portions 11 and 11, and intersection portions 12d.

### Parallel Rib

The parallel rib 12a extends downward from an intermediate portion of the coupling wall portion 12 in the vehicle width direction. The parallel rib 12a extends in the front-rear direction and is formed in parallel to the pair of opposed wall portions 11 and 11. The parallel rib 12a intersects the plurality of bridging ribs.

### Straight Ribs

The straight ribs 12b extend downward from the coupling wall portion 12. The straight ribs 12b extend straightly in a direction crossing the pair of opposed wall portions 11 and 11 (a direction perpendicular to the pair of opposed wall portions 11 and 11, i.e., the vehicle width direction, in the present embodiment). Both end portions of the straight ribs 12b are each joined to the opposed wall portion 11, and intermediate portions of the straight ribs 12b intersect the parallel rib 12a.

### V-Shaped Ribs

The V-shaped ribs 12c extend downward from the coupling wall portion 12. The V-shaped ribs 12c assume a V-shape inclined so as to extend inward in the front-rear direction of the vehicle body (rearward in the present embodiment) from the opposed wall portions 11 and 11 (end portions of the V-shaped ribs 12c) toward the parallel rib 12a (intermediate portions of the V-shaped ribs 12c). That is, both end portions of the V-shaped ribs 12c are each joined to the opposed wall portion 11, and the intermediate portions of the V-shaped ribs 12c (the vertex of the V-shape) intersect the parallel rib 12a.

### Intersection Portions

The intersection portions 12d are portions which the parallel rib 12a and the bridging ribs (the straight ribs 12b and/or the V-shaped ribs 12c) intersect. The intersection portions 12d function also as portions to be pushed out of the die-casting die by ejection pins in the formation by the aluminum die casting method. The dimension of the intersection portions 12d in the thickness direction is larger than the dimensions of the parallel rib 12a and the bridging ribs (the straight ribs 12b and/or the V-shaped ribs 12c) in the thickness direction. In the present embodiment, the intersection portions 12d assume the shape of a circular column, and the diameter of the intersection portions 12d is larger than the dimensions of the parallel rib 12a and the bridging ribs (the straight ribs 12b and/or the V-shaped ribs 12c) in the thickness direction.

One set of a bridging rib(s) (a straight rib 12b and/or a V-shaped rib 12c) and an intersection portion 12d is disposed between two fragile portions 11a arrayed in front of and behind them. To put it differently, a fragile portion 11a is disposed between two sets of a bridging rib(s) (a straight rib 12b and/or a V-shaped rib 12c) and an intersection portion 12d arrayed in front of and behind it. Both end portions of each V-shaped rib 12c are joined to rear end portions of fragile portions 11a of the opposed wall portions 11 or portions rearward of the fragile portions 11a.

The frontmost V-shaped rib 12c is joined to the frontmost intersection portion 12d. The end portions of the frontmost V-shaped rib 12c are joined to front end portions of the opposed wall portions 11 (boundary portions between the opposed wall portion 11 and the flat plate portion 13).

The second V-shaped rib 12c from the front and the frontmost straight rib 12b are joined to the second intersection portion 12d from the front.

The third V-shaped rib 12c from the front and the second straight rib 12b from the front are joined to the third intersection portion 12d from the front.

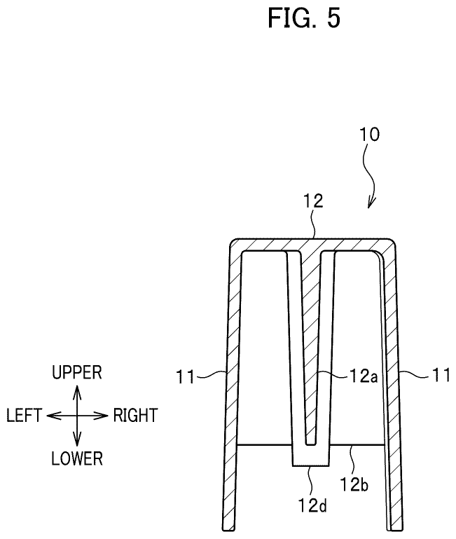

As shown in FIG. 5, the upright heights of the parallel rib 12a and the bridging ribs (the straight ribs 12b and the V-shaped ribs 12c) (the dimensions from the coupling wall portion 12 to the tips of the ribs) are smaller than the dimension of the opposed wall portion 11 in the width direction (the dimension in the upper-lower direction in the present embodiment). Also, the upright height of the intersection portions 12d (the dimension from the coupling wall portion 12 to the tips of the intersection portions 12d) is larger than the upright heights of the parallel rib 12a and the bridging ribs (the straight ribs 12b and the V-shaped ribs 12c) and smaller than the dimension of the opposed wall portion 11 in the width direction.

### Flat Plate Portion

As shown in FIG. 4, the flat plate portion 13 is a wall portion (front wall portion) laid between the pair of opposed wall portions 11 and 11 and over one end portion of the coupling wall portion 12 in the longitudinal direction (a front end portion in the present embodiment). The flat plate portion 13 is a portion to which to mount the vehicle's bumper (bumper beam) directly or with another member interposed therebetween.

### Side Frame: Second Part

The second part 20 is a part to be coupled to the inner end portion of the coupling part 5 in the vehicle width direction. The second part 20 integrally includes a pair of opposed wall portions 21 and 21, a coupling wall portion 22, and a flat plate portion 23.

### Opposed Wall Portions

The opposed wall portions 21 and 21 are long plate-shaped portions extending in the front-rear direction, and are separated from and opposed to each other. In the present embodiment, the opposed wall portions 21 and 21 extend in the front-rear direction and in the upper-lower direction, and are separated from and opposed to each other in the vehicle width direction. Front end portions of the opposed wall portions 21 and 21 are joined to rear end portions of the opposed wall portions 11 and 11, respectively. One of the opposed wall portions 21 and 21 is an inner wall portion disposed on the inner side in the vehicle width direction while the other of the opposed wall portions 21 and 21 is an outer wall portion disposed on the outer side in the vehicle width direction.

### Fragile Portion

At least one fragile portion 21a is formed on each opposed wall portion 21. The fragile portion 21a is formed to be more fragile than other portions of the opposed wall portion 21, more specifically, formed to be deformed in a collapsing manner (crushed) by a load in the front-rear direction. In the present embodiment, the fragile portion 21a is a bead (recess) recessed toward the inner side of the opposed wall portion 21. When there are a plurality of fragile portions 21a, the plurality of fragile portions 21a are arrayed in the front-rear direction (the longitudinal direction of the opposed wall portion 21). In the present embodiment, the fragile portion 21a formed on the opposed wall portion 21 which is the inner wall portion is recessed outward in vehicle width direction, while the fragile portion 21a formed on the opposed wall portion 21 which is the outer wall portion is recessed inward in the vehicle width direction.

### Coupling Wall Portion

The coupling wall portion 22 is formed so as to couple the pair of opposed wall portions 21 and 21. A front end portion of the coupling wall portion 22 is joined to a rear end portion of the coupling wall portion 12. In the present embodiment, the coupling wall portion 22 is an upper wall portion extending in the front-rear direction and in the vehicle width direction and coupling upper end portions of the pair of opposed wall portions 21 and 21 to each other.

On the coupling wall portion 22, a parallel rib 22a is formed in parallel to the opposed wall portions 21 and 21.

### Parallel Rib

The parallel rib 22a extends downward from an intermediate portion of the coupling wall portion 22 in the vehicle width direction. The parallel rib 22a extends in the front-rear direction and is formed in parallel to the pair of opposed wall portions 21 and 21. A front end portion of the parallel rib 22a is joined to a rear end portion of the parallel rib 12a. A rear end portion of the parallel rib 22a is joined to the flat plate portion 23.

### Flat Plate Portion

The flat plate portion 23 is a wall portion (rear wall portion) laid between the pair of opposed wall portions 21 and 21 and over one end portion of the coupling wall portion 22 in the longitudinal direction (a rear end portion in the present embodiment).

### Side Frame: Third Part

As shown in FIG. 3, the third part 30 is a part to be coupled to a lower end portion of a front part of the wheel house 6. The third part 30 integrally includes a pair of opposed wall portions 31 and 31, a coupling wall portion 32 coupling the opposed wall portions 31 and 31, and a flat plate portion 33.

### Opposed Wall Portions

The opposed wall portions 31 and 31 are long plate-shaped portions extending in the front-rear direction, and are separated from and opposed to each other. In the present embodiment, the opposed wall portions 31 and 31 extend in the front-rear direction and in the vehicle width direction, and are separated from and opposed to each other in the upper-lower direction. Specifically, one of the opposed wall portions 31 and 31 is an upper wall portion disposed on the upper side while the other of the opposed wall portions 31 and 31 is a lower wall portion disposed on the lower side in the vehicle width direction. A front end portion of the opposed wall portion 31 which is the upper wall portion is joined to a rear end portion of the coupling wall portion 22.

### Coupling Wall Portion

The coupling wall portion 32 is formed so as to couple the pair of opposed wall portions 31 and 31. In the present embodiment, the coupling wall portion 32 is an inner wall portion extending in the front-rear direction and in the upper-lower direction and coupling inner end portions of the pair of opposed wall portions 31 and 31 in the vehicle width direction to each other. A front end portion of the coupling wall portion 32 is joined to a rear end portion of the opposed wall portion 21 which is an inner wall portion. An upper end portion of the coupling wall portion 32 is joined to the lower end portion of the wheel house 6.

On the coupling wall portion 32, there are formed a parallel rib 32a being parallel to the opposed wall portions 31 and 31, a plurality of straight ribs 32b and V-shaped ribs 32c as bridging ribs laid between the opposed wall portions 31 and 31, and intersection portions 32d.

### Parallel Rib

The parallel rib 32a extends outward in the vehicle width direction from an intermediate portion of the coupling wall portion 32 in the upper-lower direction. The parallel rib 32a extends in the front-rear direction and is formed in parallel to the pair of opposed wall portions 31 and 31. The parallel rib 32a intersects the plurality of bridging ribs. A front end portion of the parallel rib 32a is joined to the flat plate portion 23 (see FIG. 4). A rear end portion of the parallel rib 32a is joined to the flat plate portion 33.

### Straight Ribs

The straight ribs 32b extend outward in the vehicle width direction from the coupling wall portion 32. The straight ribs 32b extend straightly in a direction crossing the pair of opposed wall portions 31 and 31 (a direction perpendicular to the pair of opposed wall portions 31 and 31, i.e., the front-rear direction, in the present embodiment). Both end portions of the straight ribs 32b are each joined to the opposed wall portion 31, and intermediate portions of the straight ribs 32b intersect the parallel rib 32a.

### V-shaped Ribs

The V-shaped ribs 32c extend outward in the vehicle width direction from the coupling wall portion 32. The V-shaped ribs 32c assume a V-shape inclined so as to extend rearward from the opposed wall portions 31 and 31 (end portions of the V-shaped ribs 32c) toward the parallel rib 32a (intermediate portions of the V-shaped ribs 32c). That is, both end portions of the V-shaped ribs 32c are each joined to the opposed wall portion 31, and the intermediate portions of the V-shaped ribs 32c (the vertex of the V-shape) intersect the parallel rib 32a.

### Intersection Portions

The intersection portions 32d are portions which the parallel rib 32a and the bridging ribs (the straight ribs 32b and/or the V-shaped ribs 32c) intersect. The intersection portions 32d function also as portions to be pushed out of the die-casting die by ejection pins in the formation by the aluminum die casting method. The dimension of the intersection portions 32d in the thickness direction is larger than the dimensions of the parallel rib 32a and the bridging ribs (the straight ribs 32b and/or the V-shaped ribs 32c) in the thickness direction. In the present embodiment, the intersection portions 32d assume the shape of a circular column, and the diameter of the intersection portions 32d is larger than the dimensions of the parallel rib 32a and the bridging ribs (the straight ribs 32b and/or the V-shaped ribs 32c) in the thickness direction.

### Flat Plate Portion

The flat plate portion 33 is a wall portion (rear wall portion) laid between the pair of opposed wall portions 31 and 31 and over an end portion of the coupling wall portion 32 on the rear side in the front-rear direction of the vehicle body (a rear end portion in the present embodiment).

### Side Frame: Fourth Part

The fourth part 40 is a part to be coupled to a lower end portion of a rear part of the wheel house 6. The fourth part 40 integrally includes a pair of opposed wall portions 41 and 41 and a coupling wall portion 42 coupling the opposed wall portions 41 and 41.

### Opposed Wall Portions

The opposed wall portions 41 and 41 are long plate-shaped portions extending in the front-rear direction, and are separated from and opposed to each other. In the present embodiment, the opposed wall portions 41 and 41 extend in the front-rear direction and in the vehicle width direction, and are separated from and opposed to each other in the upper-lower direction. Specifically, one of the opposed wall portions 41 and 41 is an upper wall portion disposed on the upper side while the other of the opposed wall portions 41 and 41 is a lower wall portion disposed on the lower side. A front end portion of the opposed wall portion 41 which is the upper wall portion is joined to a rear end portion of the coupling wall portion 31 which is an upper wall portion. A front end portion of the opposed wall portion 41 which is the lower wall portion is joined to a rear end portion of the coupling wall portion 31 which is a lower wall portion.

### Coupling Wall Portion

The coupling wall portion 42 is formed so as to couple the pair of opposed wall portions 41 and 41. In the present embodiment, the coupling wall portion 42 is an inner wall portion extending in the front-rear direction and in the upper-lower direction and coupling inner end portions of the pair of opposed wall portions 41 and 41 in the vehicle width direction to each other. A front end portion of the coupling wall portion 42 is joined to a rear end portion of the coupling wall portion 32, which is an inner wall portion. An upper end portion of the coupling wall portion 42 is joined to the lower end portion of the wheel house 6. A rear end portion of the coupling wall portion 42 is joined to the wheel house 6.

On the coupling wall portion 42, there are formed a plurality of parallel ribs 42a being parallel to the opposed wall portions 41 and 41, a plurality of straight ribs 12b as bridging ribs laid between the opposed wall portions 41 and 41, and intersection portions 42d.

### Parallel Ribs

The parallel ribs 42a extend outward in the vehicle width direction from an intermediate portion of the coupling wall portion 42 in the upper-lower direction. The parallel ribs 42a extend in the front-rear direction and are formed in parallel to the pair of opposed wall portions 41 and 41. Front end portions of the parallel ribs 42a are joined to the flat plate portion 33. Rear end portions of the parallel ribs 42a are joined to the wheel house 6.

### Straight Ribs

The straight ribs 42b extend outward in the vehicle width direction from the coupling wall portion 42. The straight ribs 42b extend straightly in a direction crossing the pair of opposed wall portions 41 and 41 (a direction perpendicular to the pair of opposed wall portions 41 and 41, i.e., the front-rear direction, in the present embodiment). Both end portions of the straight ribs 42b are each joined to the opposed wall portion 41, and intermediate portions of the straight ribs 42b intersect the parallel ribs 42a.

### Intersection Portions

The intersection portions 42d are portions which the parallel ribs 42a and the bridging ribs (the straight ribs 42b) intersect. The intersection portions 42d function also as portions to be pushed out of the die-casting die by ejection pins in the formation by the aluminum die casting method. The dimension of the intersection portions 42d in the thickness direction is larger than the dimensions of the parallel ribs 42a and the bridging ribs (the straight ribs 42b) in the thickness direction. In the present embodiment, the intersection portions 42d assume the shape of a circular column, and the diameter of the intersection portions 42d is larger than the dimensions of the parallel ribs 42a and the bridging ribs (the straight ribs 42b) in the thickness direction.

### Fifth Part

The fifth part 50 is a part to be coupled to a lower end portion of a rear part of the wheel house 6. The fifth part 50 is formed so as to extend farther downward and outward in the vehicle width direction toward the rear side and is capable of transmitting a frontal collision load to a frame of a vehicle body structure member behind the front member 2 (such as a side sill).

### Transmission of Collision Load Through Side Frames, Etc.

In each side frame 3, the first part 10 is designed to have lower strength against frontal collision loads than the second, third, fourth, and fifth parts 20, 30, 40, and 50. Specifically, during a frontal collision of the vehicle, the first part 10 is preferentially destroyed by the frontal collision load input through the bumper to thereby absorb the energy of the frontal collision (collision energy).

The first part 10 gets crushed at the frontmost fragile portions 11a.

Here, the strength of the rear side of the frontmost fragile portions 11a is enhanced by one set of a straight rib 12b, a V-shaped rib 12c, and an intersection portion 12d, so that a region R1 of the first part 10 between the flat plate portion 13 and the straight rib 12b, V-shaped rib 12c, and intersection portion 12d behind the frontmost fragile portions 11a gets bent.

Subsequently, the first part 10 gets crushed at the second fragile portions 11a from the front. Here, the strength of the rear side of the second fragile portions 11a from the front is enhanced by one set of a straight rib 12b, a V-shaped rib 12c, and an intersection portion 12d, so that a region R2 of the first part 10 between the flat plate portion 13 and the straight rib 12b, V-shaped rib 12c, and intersection portion 12d behind the second fragile portions 11a from the front gets bent.

Note that the gap between the opposed wall portions 11 and 11 in the region corresponding to the frontmost fragile portions 11a is narrower than the gap between the opposed wall portions 11 and 11 in the region corresponding to the second fragile portions 11a from the front. That is, in the first part 10, the strength of the region R1 corresponding to the frontmost fragile portions 11a is lower than the strength of the region R2 corresponding to the second fragile portions 11a from the front. This enables the first part 10 to be reliably crushed and bent at the crush and bend of the region R1 corresponding to the frontmost fragile portions 11a before the region R2 corresponding to the second fragile portions 11a from the front.

Subsequently, the frontal collision load whose energy was not absorbed by the first part 10 is transmitted to the second part 20. Part of the frontal collision load transmitted to the second part 20 is transmitted through the third, fourth, and fifth parts 30, 40, and 50 to a frame of a vehicle body member behind the front member 2 (such as the side sill). Also, another part of the frontal collision load transmitted to the second part 20 is transmitted through the coupling part 5 and the upper member 4 to a frame of the vehicle body member behind the front member 2 (such as a front pillar). Here, the second part 20 absorbs part of the frontal collision energy by being crushed and bent at the fragile portions 21a.

The vehicle frame structure according to the embodiment of the present invention (the front member 2, the side frame 3, the first part 10) includes: a pair of opposed wall portions 11 and 11 extending in a front-rear direction of a vehicle body; a coupling wall portion 12 extending in the front-rear direction of the vehicle body and coupling the pair of opposed wall portions 11 and 11 to each other; a plurality of bridging ribs formed so as to couple the pair of opposed wall portions 11 and 11 to the coupling wall portion 12; and a fragile portion 11a formed on the opposed wall portions 11 and/or the coupling wall portion 12. The fragile portions 11a are formed to be located between two adjacent ones of the bridging ribs in the front-rear direction of the vehicle body.

Thus, by including fragile portions 11a between bridging ribs that are adjacent in a cross section of the frame, the vehicle frame structure can repetitively exert a reaction force at a bridging rib against a load in the front-rear direction and be crushed at the corresponding fragile portions. This makes it possible to efficiently absorb collision energy.

The vehicle frame structure further includes a parallel rib 12a formed at an intermediate portion of the coupling wall portion 12 in the vehicle width direction so as to couple the plurality of bridging ribs to each other.

In this way, the parallel rib 12a and the bridging ribs are coupled so as to intersect. This improves the vehicle frame structure's frame rigidity and increases the amount of collision energy which the vehicle frame structure can absorb. Also, the vehicle frame structure stops crush of the fragile portions 11a at each intersection portion 12d. This makes it possible to shorten the crush range (crush distance) and cause crush to occur in a sequential manner and thus improve the efficiency of absorption of collision energy.

The vehicle frame structure includes V-shaped ribs 12c as the bridging ribs that are formed so as to couple the pair of opposed wall portions 11 and 11 to each other through the intersection portions 12d at which the V-shaped ribs 12c intersect the parallel rib 12a.

the V-shaped ribs 12c are each formed so as to couple inner end portions of the fragile portions 11a of the opposed wall portions 11 in the front-rear direction of the vehicle body or portions of the opposed wall portions 11 located inward of the fragile portions 11a in the front-rear direction of the vehicle body to the intersection portion 12d disposed inward of the fragile portions 11a in the front-rear direction of the vehicle body, and a vertex of the V-shaped rib 12c is located at the intersection portion 12d.

In this way, the vehicle frame structure reliably gets crushed at the fragile portions 11a by the difference in strength between the fragile portions 11a and the V-shaped rib 12c located inward thereof in the front-rear direction of the vehicle body. This makes it possible to control the crush mode in a preferable manner to improve the efficiency of absorption of collision energy.

The vehicle frame structure includes straight ribs 12b as the bridging ribs that intersect the parallel rib 12a, and the V-shaped ribs 12c are each disposed between the fragile portions 11a and the corresponding straight rib 12b.

In this way, the vehicle frame structure more reliably gets crushed at the fragile portions 11a by the difference in strength between the fragile portions 11a and the V-shaped rib 12c and the straight rib 12b located inward thereof in the front-rear direction of the vehicle body. This makes it possible to control the crush mode in a preferable manner to further improve the efficiency of absorption of collision energy.

The vehicle frame structure includes straight ribs 12b as the bridging ribs that intersect the parallel rib 12a.

In this way, the vehicle frame structure reliably gets crushed at the fragile portions 11a by the difference in strength between the fragile portions 11a and the straight rib 12b located inward thereof in the front-rear direction of the vehicle body. This makes it possible to control the crush mode in a preferable manner to improve the efficiency of absorption of collision energy.

In the vehicle frame structure, the intersection portions 12d at which the bridging ribs and the parallel rib 12b intersect assume a columnar shape.

In this way, the vehicle frame structure improves the rigidity of the intersection portions 12d to thereby improve the support performance against collision loads and also stop crush of the fragile portions 11a on the outer side in the front-rear direction of the vehicle body in a preferable manner. Also, the vehicle frame structure ensures rigidity against collisions from other directions than the front-rear direction of the vehicle body.

In the vehicle frame structure, the gap between the pair of opposed wall portions 11 and 11 widens toward the inner side in the front-rear direction of the vehicle body.

In this way, the vehicle frame structure gets crushed proactively at a region on the outer side in the front-rear direction of the vehicle body that has a smaller cross section and gets crushed less at a region on the inner side in the front-rear direction of the vehicle body that has a larger cross section (than on the outer side in the front-rear direction of the vehicle body that has a smaller cross section). This protects peripheral members disposed around the latter region.

The vehicle frame structure is a side frame 3 disposed outward of a wheel house 6 in the front-rear direction of the vehicle body.

In this way, the vehicle frame structure proactively absorbs collision energy in the front-rear direction of the vehicle body while reducing its influence on the wheel.

The vehicle frame structure integrally includes the wheel house 6.

In this way, the vehicle frame structure proactively absorbs collision energy in the front-rear direction of the vehicle body while reducing its influence on the wheel, and integrating the side frame 3 and the wheel house 6 with each other improves the manufacturability of the vehicle body.

The vehicle frame structure is formed by an aluminum die casting method.

In this way, the vehicle frame structure achieves improved collision energy absorption performance while also achieving recyclability, CO2 emission reduction, and high rigidity.

While an embodiment of the present invention has been described above, the present invention is not limited to the embodiment, and changes can be made as appropriate without departing from the gist of the present invention. For example, the opposed wall portions 11 and 11 may be an upper wall portion and a lower wall portion, and the coupling wall portion may be an inner wall portion coupling inner end portions of the upper wall portion and the lower wall portion in the vehicle width direction to each other. Also, the fragile portions are not limited to beads, and may be thin portions formed to be thinner than other portions. Also, the fragile portions may be formed on the coupling wall portion. Specifically, the fragile portions may be formed on the coupling wall portion instead of the opposed wall portions, or formed across (at least one of) the pair of opposed wall portions and the coupling wall portion. Also, the vehicle body structure member to which the vehicle frame structure is applied is not limited to the one described above. For example, a configuration may be employed which integrally includes the pair of front members 2 and 2, a dash panel coupling the front members 2 and 2 to each other, and front pillars as a pair in the vehicle width direction that are joined to rear end portions of the side frames 3 and the upper members 4 and extend in the upper-lower direction. Also, the vehicle frame structure of the present invention is applicable to a rear section of a vehicle body as well.

What is claimed is:

1. A vehicle frame structure comprising:
a pair of opposed wall portions extending in a front-rear direction of a vehicle body;
a coupling wall portion extending in the front-rear direction of the vehicle body and coupling the pair of opposed wall portions to each other;
a plurality of bridging ribs formed so as to couple the pair of opposed wall portions to the coupling wall portion; and
a fragile portion formed on the opposed wall portions and/or the coupling wall portion, wherein
the fragile portion is formed to be located between two adjacent ones of the bridging ribs in the front-rear direction of the vehicle body.

2. The vehicle frame structure according to claim 1, further comprising a parallel rib formed at an intermediate portion of the coupling wall portion in a vehicle width direction so as to couple the plurality of bridging ribs to each other.

3. The vehicle frame structure according to claim 2, wherein
the vehicle frame structure includes V-shaped ribs as the bridging ribs that are formed so as to couple the pair of opposed wall portions to each other through intersection portions at which the V-shaped ribs intersect the parallel rib,
the V-shaped ribs are each formed so as to couple inner end portions of the fragile portions of the opposed wall portions in the front-rear direction of the vehicle body or portions of the opposed wall portions located inward of the fragile portions in the front-rear direction of the vehicle body to the intersection portion disposed inward of the fragile portions in the front-rear direction of the vehicle body, and
a vertex of the V-shaped rib is located at the intersection portion.

4. The vehicle frame structure according to claim 3, wherein
the vehicle frame structure includes straight ribs as the bridging ribs that intersect the parallel rib, and
the V-shaped ribs are each disposed between the fragile portions and the corresponding straight rib.

5. The vehicle frame structure according to claim 2, wherein the vehicle frame structure includes straight ribs as the bridging ribs that intersect the parallel rib.

6. The vehicle frame structure according to claim 2, wherein intersection portions at which the bridging ribs and the parallel rib intersect assume a columnar shape.

7. The vehicle frame structure according to claim 1, wherein a gap between the pair of opposed wall portions widens toward an inner side in the front-rear direction of the vehicle body.

8. The vehicle frame structure according to claim 1, wherein the vehicle frame structure is a side frame disposed outward of a wheel house in the front-rear direction of the vehicle body.

9. The vehicle frame structure according to claim 8, wherein the vehicle frame structure integrally includes the wheel house.

10. The vehicle frame structure according to claim 1, wherein the vehicle frame structure is formed by an aluminum die casting method.
